(19) United States
(12) Patent Application Publication
(10) Pub. No.: US 2006/0098207 A1
(43) Pub. Date: May 11, 2006

(54) Interferometric method for the measurement of separations between planes with subnanometer precision

(75) Inventors: Edmund Koch, Dresden (DE); Peter Koch, Luebeck (DE)

Correspondence Address: LARSON AND LARSON, 11199 69TH STREET NORTH, LARGO, FL, 33773, US

(73) Assignee: MEDIZINISCHES LASERZENTRUM LUEBECK GMBH

(21) Appl. No.: 11/316,619

(22) Filed: Dec. 16, 2005

Related U.S. Application Data
(63) Continuation-in-part of application No. PCT/DE04/01208, filed on Jun. 14, 2004.

(30) Foreign Application Priority Data
Jun. 19, 2003 (DE) 103 28 412.5

(51) Int. Cl. G01B 11/02

(52) U.S. Cl. 356/504

(57) ABSTRACT

Method for the interferometric determination of the change to an optical spacing between two planes in a sample at a transition from a first to a second measurement point on the sample, the sample being illuminated with high band width light and the sample is at least partly transmitting for the light and the planes that are partly reflecting, with the steps of the spectral dispersion of the superposition of the light beams reflected at the planes for both measurement points. A determination of the modulation frequencies and phase positions of the spectrograms and the differentiation of these results can be made for providing a conclusion concerning a first value for the optical separation change of the planes from the difference of the modulation frequencies alone and calculation of a second, more precise value for the optical separation change from the first value, while taking account of the phase difference.

### PRIOR APPLICATIONS

This application is a continuation-in-part of International Application No. PCT/DE2004/001208, filed on Jun. 14, 2004, which in turn bases priority on German Application No. 103 28 412.5, filed on Jun. 19, 2003.

### BACKGROUND OF THE INVENTION

1. Field of Invention

This invention relates to a method and device for the non-contacting determination of the separation between at least one partially reflecting plane, said plane located in or on a sample from a pre-selected, partly reflecting reference plane of the sample, said determination made by illuminating the sample with broad band light and evaluating an interference phenomenon.

2. Description of the Prior Art

Typical reflector planes in the sense of the invention are interfaces between media with differing refractive indices. Typical reference planes in the sense of the invention are smooth surfaces of high reflectivity, particularly at the air-sample interface, i.e. sample surfaces. Smooth surfaces are those whose surface roughness (=variance of the z-components of the surface elements, so-called pixels) are very small compared with the illuminating light wavelengths. In particular, smooth surfaces are to be looked upon as ideal mirrors producing no speckle patterns.

In several sectors of nanotechnology, coatings of a few molecular layers are applied to carrier substances. Generally the quality of these coatings is optically monitored by white light interferometry, ellipsometry or surface plasmon resonance spectroscopy. Another possibility consists of fluorescent secondary reagents being applied and which are selectively bound to the coating in order to then examine the surface coverage by fluorescence microscopy. For precise measurements with both high lateral and also axial resolution, use is made of confocal microscopic systems or raster probe methods, such as e.g. raster force microscopy. It is common to all these methods that considerable technical effort and expenditure is involved and, in the case of high lateral resolution, a large amount of time is required for each scan, which generally renders impossible a continuous quality control.

Uses for the measurement of molecular coatings occur, inter alia, in medicine and biotechnology, e.g. in the coating of DNA or protein chips oligonucleotides or antibodies which are normally geometrically arranged on a surface, e.g. as dot rasters along a microfluidic channel boundary. For quantitative evaluation purposes, it is desirable to have a uniform, dense average coverage, which is sufficiently loose so that there is no mutual hindrance of the target structures. It is particularly important to establish whether aggregates have formed on the surface, because such aggregates are generally undesired. Geometrical coating thicknesses of approximately 5 to 10 nm are to be detected.

Further uses for profilometers with nanometer precision occur in the production of semiconductor products, polished materials, optics, magnetic storage media and for lithographic structures and microstructures. This generally relates to all industrial processes for the surface treatment of materials in which it is necessary to determine very small coating thickness differences over relatively extensive surfaces. In such cases, raster probe microscopy is ineffective and too expensive.

Optical profilometers, which scan the surface structure of a sample in non-contacting manner, exist in numerous variants in the prior art. Typical methods are so-called phase shift and white light interferometry.

In phase shift interferometry (PI), coherent light is deflected by means of a beam splitter into the reference and sample arm of an interferometer. The reference mirror is arranged in mobile manner along the reference arm, so that the length of the latter is variable, preferably uniformly. Through the periodic adjustment of the mirror, the reference light is phase-modulated. Superimposed on the light reflected by the sample surface is the phase-modulated reference light, which leads to a time-variable interferogram on a detection device, whose evaluation permits the position determination of the local sample mirror, i.e. the surface area illuminated during a lateral sample scan, with high precision (a few nanometers) relative to a fixed reference plane. However, if the surface variation relative to the reference plane exceeds half the light wavelength, ambiguities occur with respect to the position determination, because 2-modulated sample light then leads to the same interferograms (2 ambiguity). Similar difficulties arise with rough surfaces, where the sample light has a statistically dispersed phase. EP 498 541 A1 takes up this disadvantage and, for improvement purposes, proposes the simultaneous measurement with at least two different wavelengths. However, the main disadvantage of PI is the complex apparatus that is required, which in particular, always comprises laser light sources and phase modulators for the reference light.

Use is frequently made of white light interferometry (WLI) for the measurement of rough surfaces. DE 41 08 944 C2 e.g. describes an interferometer based on the Michelson structure, in which short-coherent light from a filament lamp or superluminescent LED (SLD) is deflected into a reference and sample arm, the reference mirror and sample being mounted in a mobile manner. Provided that the coherence length of the light is not made smaller than the peak to valley height of the surface, speckles arise and their intensity varies along the beam direction during the shifting of the mirror (or sample). This makes it possible to determine the surface profile in the illuminated area of the probe with a typical precision of around 100 nm. This is admittedly small compared with PI, but no laser light sources are required and the 2 problem does not arise.

U.S. Pat. No. 5,953,124 describes a combination of PI and WLI, in which time-dependent 2D interferograms are produced and evaluated with short-coherent light on detector planes.

A modification of WLI is described in DE 692 27 902 T2. If the sample partly transmits probing light and back-scatters it in different depth planes, in the case of a small aperture sample illumination and by blocking out the light components scattered with lateral displacement, it is possible to obtain a point-sized depth scan of the sample. This measuring method is known as “optical coherent tomography” (OCT), wherein the depth determination of the scattering centers takes place with a short coherence length of the light through the knowledge of the time-variable reference arm length. Typical scan depths of modern OCT systems are up to 2 mm in the case of a vertical resolution of about 10 μm. Standard uses include in vivo examination of biological samples and tissue, and in particular, the retina of the eye.

U.S. Pat. No. 6,359,692 B1 describes a profilometer with phase modulator and tuneable light source for examining samples, in which several reflector planes simultaneously contribute to the interference. The purpose here is to block out of interfering influences of additional reflectors on the interference pattern.

All of the prior art methods and devices referred to hereinbefore have the common feature that they contain movable parts for influencing the light paths and also that the reference arm and measurement arm of the interferometer are always dealt with differently. Typically, the measurement beam and reference beam are guided in light guide fibres, but are never exposed to identical ambient conditions. Accordingly, this difference leads to uncontrolled deviations between the paths. In addition, any fibre movement can lead to length changes in the μm range, an undesirable result.

WO 02/084263 discloses an OCT system which is improved in the respect that it does not require moving parts. The depth-resolved scattering power of a sample is calculated via the transit time distribution of the back-scattered light from an interferogram on a photodiode line, which can be produced by an arrangement based on the conventional two-slit experiment. There is no interferometer reference arm. Instead, the reference mirror is transferred into the sample arm. The reference can be given e.g. by light reflected or back-scattered from the sample surface. The reference and sample light are guided via a common fibre into the analytical unit and are superimposed there. In this manner, interference by ambient and motion influences are minimized.

A tomographic method constituting an alternative to OCT can be gathered from DE 43 09 056 A1 and is referred to as “spectral radar”. In this method, light from a broad band light source is scattered in the sample in a plane with a separation z from a reference plane (z=0) and on it is superimposed back-scattered light from the reference plane. This leads to constructive or destructive interference for a random, fixed plane separation z, as a function of which the beamed in wavelengths are considered. If the back-scattering involves a plurality of planes with separations from a range [z1, z2] with respect to the reference plane, then the starting intensity I(λ) is to be considered as an integral over this range. On using broad band light, e.g. from a SLD, the interference light is spectrally dispersed and normally imaged on a photodiode line or a comparable device. This permits the measurement of the dispersion I(k), k=2π/λ as a spatial dispersion or distribution on the sensor line. A Fourier transformation thereof leads to the depth-dependent scattering power S(z). This method also involves a relatively simple apparatus that does not require moving elements.

The last-mentioned tomographic method, void of any moving components (so-called “No Motion”) has never hitherto been considered for high precision profiling, because it is possible to do without phase information. However, such information is also present with No Motion measurements, and in the case of a suitable evaluation of the measurements, provides conclusions concerning the reflector separations, even in the subnanometer range.

The problem of the present invention is to provide an interferometric method and an interferometer for high precision profiling of one or more reflector planes on or in a sample, the interferometer reference arm coinciding in the manner known from the prior art with the sample arm, so that there is no need to use phase modulators, and in particular mechanically moving parts.

### SUMMARY OF THE INVENTION

I have developed a method for the interferometric determination of a change to an optical separation between two planes in a sample at a transition from a first to a second measurement point on the sample, the sample being illuminated with high bandwidth light. The sample is at least partly transmitting for the high bandwidth light. The two planes are constructed in a partly reflecting manner. The method includes the steps of spectrally dispersing a superposition of light beams reflected at the two planes for both the first and second measurement points. Thereafter, a spectrogram is produced, utilizing the results from dispersing the superposition of light beams. Then modulation frequencies and phase positions are determined from the spectrogram and these results are differentiated. Thereafter, a first value for the optical separation change of the planes is calculated from a difference of the modulation frequencies. Finally, a second value for an optical spacing change is calculated from the first calculated value and a difference from the phase positions.

### BRIEF DESCRIPTION OF THE DRAWINGS

The detailed description of the invention, contained herein below, may be better understood when accompanied by a brief description of the drawings, wherein:

FIG. 1 is a typical light intensity distribution, such as that which arises through the interference of broad band light at two reflector planes with fixed separation, if the light is spectrally dispersed and is e.g. detected on a sensor line.

FIG. 2 illustrates values of Fourier coefficients of the distribution of FIG. 1.

FIG. 3 illustrates the results of a numerically simulated measurement of the separation of the reflector planes for comparing the method of the present invention with the prior art.

### DETAILED DESCRIPTION OF THE PREFERED EMBODIMENT

In the present invention, a sample is illuminated from a broad band light source, preferably a superluminescent LED (SLD). It is assumed that the sample contains at least one good reflecting plane suitable as a smooth reference plane. Usually, this is the optionally pre-treated sample surface. The illuminating light is now reflected at the reference plane and at least one further plane which are of interest, e.g. the surface of a molecular coating.

It must be appreciated that in the present method the two planes must have a minimum separation, which is preferably more than 20 μm. If it is a matter of investigating the thickness of a coating on a substrate, the substrate surface directly below the coating may not be suitable. However, if the substrate is sufficiently transparent for the measurement light, the substrate back normally provides an adequately far removed, high reflecting reference plane. This is e.g. the case for visible light and a glass disk or infrared light (λ≈1.3 μm) and silicon wafer.

Further advantages of the present method are that it is possible to simultaneously investigate several planes, provided that their separations from the reference, and preferably from one another, clearly differ. This is of interest when checking coated samples, e.g. for heterocrystals. For simplification purposes, hereinafter there is only a discussion of a case of a precisely investigated separation d between two planes.

As a result of the superimposing of the electromagnetic waves of the reference and measurement surface, by interference there is a total signal IG at the detector:
I_{G}=I_{R}+I_{M}+2\sqrt{I_{R}·I_{M}}·COS(2π2nd+/λφ₀) (1)
in which IR and IM are the intensities of the reference and measurement surfaces respectively, and n is the refractive index in the area between the planes and the wavelength (cf. Bergmann-Sch,,fer: Optik, 9th edition, p 304). If the two reflected waves have a different phase (different phases can arise as a result of the sign of the refractive index transition or in the case of media with a complex refractive index, such as metals), an additional phase φ₀ is added, which is generally not strongly dependent on the wavelength and which can therefore be assumed as constant in a limited spectral range. This formula applies to two-beam interference, e.g. in the Michelson interferometer, but also constitutes a good approximation in the case of multiple-beam interference, such as that which arises in an etalon, provided that the reflecting power of both surfaces is small (cf. Bergmann-Sch,,fer: Optik, 9th edition, p 338). In the case of broad band light sources, the intensities I_{R} and I_{M} are only slightly dependent on the wavelength. As a result of high pass filtering only the strongly wavelength-dependent interference term from equation (1) is used for analysis and is designated I_{W}. As a function of the wave number ν=1/λ the alternating signal is:
IW=2\sqrt{I_{R}·IM}·COS(2π·2ndν+φ₀) (2)

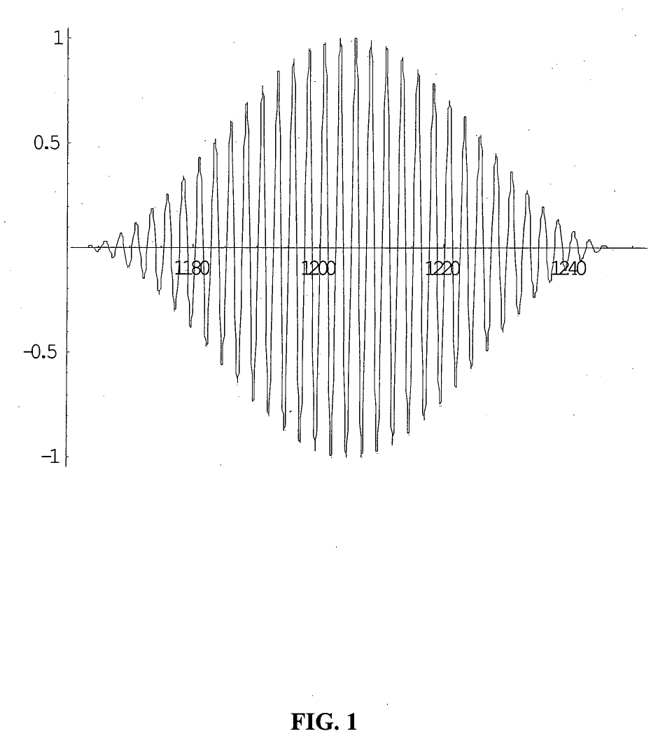

The interference signal is an amplitude-modulated periodic function with respect to ν, which is only present in a small spectral range, and which is bounded by the spectrometer and the light source (see FIG. 1 as an example). Standard evaluation subjects the alternating signal I_{W} plotted against ν to a Fourier transformation, which determines the spatial frequency with the largest signal and identifies this with the sought after quantity nd. The prerequisite is that the refractive index n is adequately and/or precisely known an, in good approximation, is constant in the spectral range used, so that in principle the d determination problem is solved.

However, as the signal is generally only determined at a few (e.g. 1024) discreet support points, it is subject to a discreet, fast Fourier analysis (FFT) and use is made of the highest value Fourier component (peak). If the spectral range Δν is used for the analysis, then the term 2nd is obtained in units of 1/Δν, i.e. only an approximation to the true value, e.g. for the spectral range 800 to 860 nm, Δν=87 mm⁻¹. Then the channel separation of the Fourier transform 1/Δν=11.5 μm, i.e. the FFT calculated value for quantity nd has an uncertainty of approximately 6 μm, which cannot compete with standard profilometric resolutions.

Thus, to provide assistance, interpolation takes place between the discreet points of the Fourier transform. This can e.g. take place by simple parabolic interpolation in the vicinity of the peak. However, intermediate values are obtained by the known zerofilling method, but this increases the time required for Fourier transformation. Details of the result of the interpolation are dependent on an envelope curve of the signal from FIG. 1. If the signal envelope corresponds to a cosine (Hanning window), this provides a very good determination for the position of the maximum on using the parabolic interpolation, the three amplitudes around the maximum, and which of said amplitudes must undergo evaluation before an x^{0.23} operation. However, many other evaluation types are possible here.

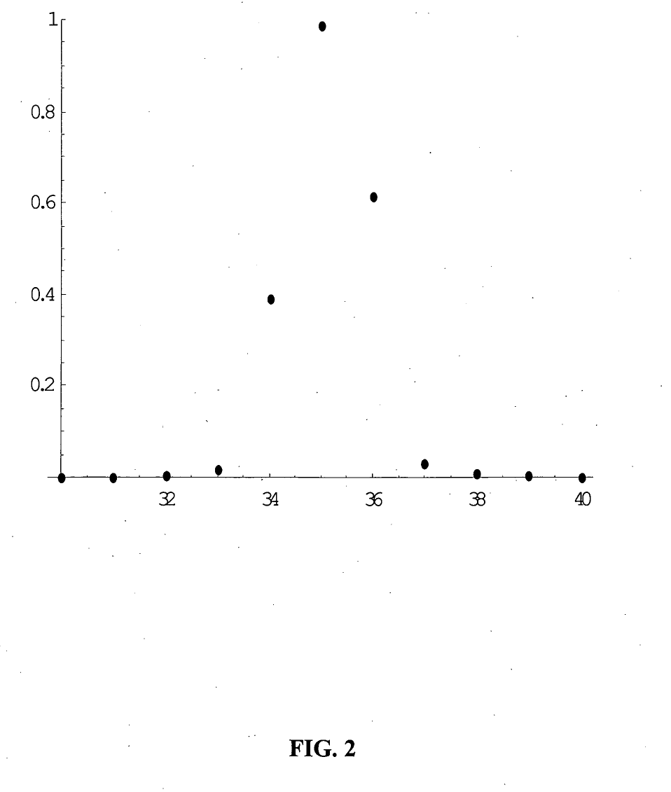

The amplitude of the Fourier transform in the vicinity of the peak is plotted in FIG. 2. It would clearly make no sense to include points other than in the peak environment in the evaluation, because the information contained therein provides little information due to the noise which is always present. Ultimately, the precision of the frequency determination is determined by the signal/noise (S/N) ratio of the input data, which determine the S/N ratio of the amplitudes which are used for evaluation purposes. As said, amplitudes scarcely enter the evaluation more strongly than linearly, but the maximum influence of the amplitudes amounts to one channel, the precision of the thickness determination is established at a value of the order of magnitude of the channel separation divided by the S/N. In figures, this means that for an S/N of 1000 or 60 dB and the aforementioned spectral range, the value nd can be precisely determined to approximately 6 nm. This is admittedly much smaller than the wavelength of light, but is still sufficient for certain applications.

A modification of the coating thickness by Δnd ≈λ/4 (approximately 210 nm, if all the wavelengths used emanate from the 800 to 860 nm window) in the spectrogram of FIG. 1 leads to a slight change to the spatial frequency, which in the case of a Fourier transformation, becomes apparent in a slight position change of the largest Fourier component. The peak does not even change with respect to the next channel. Only the values of the Fourier components of the peak and its neighbors vary in such a way that the aforementioned interpolation can find the new spatial frequency. At the same time, the spectrogram of FIG. 1 appears inverted because the additional path difference of the reference and measuring light is approximately permutated by 2Δnd ≈λ/2 extinction and amplification for all the wavelengths used. In the previous evaluation and despite its obvious sensitivity, the signal phase has been ignored.

The absolute phase φ₀ from equation (1) cannot be determined. The only phase information obtainable from the measurement data (see FIG. 1) is the phase position of the intensity distribution I_{W}(ν) relative to a selected wave number from the wave number range available (here: 1163-1250 mm⁻¹). Standard FFT routines normally give the phase, and it must be established which reference point was chosen for the phase indication.

In principle, a complex FFT is firstly carried out, so that all the components cⱼ of the Fourier series are complex numbers of form cⱼ=pⱼ exp(i φⱼ). In a preferred variant, the phase is determined from the highest value Fourier components (pⱼ=max for channel j=P). Due to cₚ=Cₚ+i Sₚ, we immediately obtain φp=arctan(Sₚ/Cₚ) with the limitation −π/2<φₚ<π/2. If the spectrum envelope is not symmetrical, it is better to determine the phase by interpolation on the predetermined spectrum maximum.

However, no additional separation information can be determined from the additional phase determination in the case of a single separation measurement at one point on a sample. Consideration must instead be given to the phase change on transition to another measurement point in order to obtain precise data concerning the plane separation difference between two measurement points.

At a first measurement point (starting point S), determination takes place of the optical separation of the planes nd_{S} and the phase φ_{S} and in the same way determination takes place of nd_{M} and φ_{M} at a random, second measurement point (M). Formation takes place of the differences Δnd:=nd_{M}−nd_{S} and Δφ:=μ_{M}− _{S}. is initially only determined up to a multiple of 2π and the following applies: −π≦Δφ≦π. The true phase difference is, however, Δφ*:=Δφ+N 2π with an initially unknown integer N. The latter is obtained in the quantity nd determined independently of the phase and can be extracted.

Δφ* changes with the spatial frequency 2nd of the intensity distribution from FIG. 1 as a result of a non-conformal shift of all extrema, i.e. Δφ*=Δφ*(ν). However, the dependence on the wave number is only weak, and a small change to the optical plane separation (order of magnitude Δnd≈λ) can be ignored. However, if the plane separation e.g. changes by half the channel separation of the Fourier transform (approx. 6 μm), an additional oscillation occurs in FIG. 1, i.e. Δφ* varies by up to 2π, as a function of which wave number has been chosen as the reference point from the range used here. It is therefore important to determine the phase at each measurement point (M) in the same way as at the starting point (S) of the measurement. If the phase at the starting point is alternatively directly calculated from FIG. 1, at the selected wave number 1/λ_{M}, e.g. at the global maximum, the phases of other measurement points must also be related to 1/λ_{M}.

Any change in the plane separation by Δnd=±λ_{M}/4 now leads to a measurable phase difference Δφ*=±π (spectrogram inversion), so that we obtain for random separation changes Δnd:

$$\frac{Δ nd}{{λ}_{M / 2}} = \frac{Δ {φ}^{*}}{2 π} = \frac{Δ nd}{{λ}_{M / 2}} = \frac{Δ φ }{2 π} N = 0 \qquad ( 3 )$$

so that the number N of whole cycles already sought in the definition of Δφ* can be directly read off by means of the measured values Δnd and Δφ. As these measured values are noisy, for the expression

$$N = \frac{Δ nd}{{λ}_{M / 2}} - \frac{Δ φ}{2 π} \qquad ( 4 )$$

initially only approximate whole numbers are obtained, which are to be rounded to integers by an evaluation algorithm (integer requirement). This precision of determination of Δnd must be adequately high for this. To check this in a measurement series, it is possible to consider the absolute divergence of (4) from an integer. For no measurement should this be higher than ¼ in order to be able to ensure the correctness of the association. However, as two measurements are involved in the determination of Δnd, the error for each individual measurement should be clearly smaller than λ_{M}/8. This not only applies to the mean error (RMS), but to virtually any value. Therefore, the triple standard deviation of the error must be well below λ_{M}/8. For a wavelength of 830 nm, this means a desired precision in the first determination of nd with an order of magnitude of 50 nm. Therefore, one is on the safe side with the above error estimate of 6 nm.

With expression (4) below, a constrained integral N is directly obtained for each measurement point and a measured value Δφ*:=Δφ+N 2π and an improved estimation for the optical plane separation can be measured by the expression

$$Δ {nd}^{*} := \frac{Δ {φ}^{*}}{2 π} \cdot {λ}_{M / 2} \qquad ( 5 )$$

The specific choice of λ_{M} is not important and for each choice of λ_{M}, Δnd* will be in the vicinity of the measured Δnd. As a possible development of the present method this, even allows the use of λ_{M} as a fit parameter in a processing after ending a sample scan. All the data of a measurement series is recorded in an evaluating unit and then e.g., with a standard minimizing algorithm, an optimum λ_{M} is sought from the spectrum used for which the expression (4) on using each measured value pair (Δnd,Δφ) only diverges from a whole number within narrow limits. In other words, from the outset the λ_{M} for which the integer requirement is best fulfilled is sought or where rounding involves the smallest intervention.

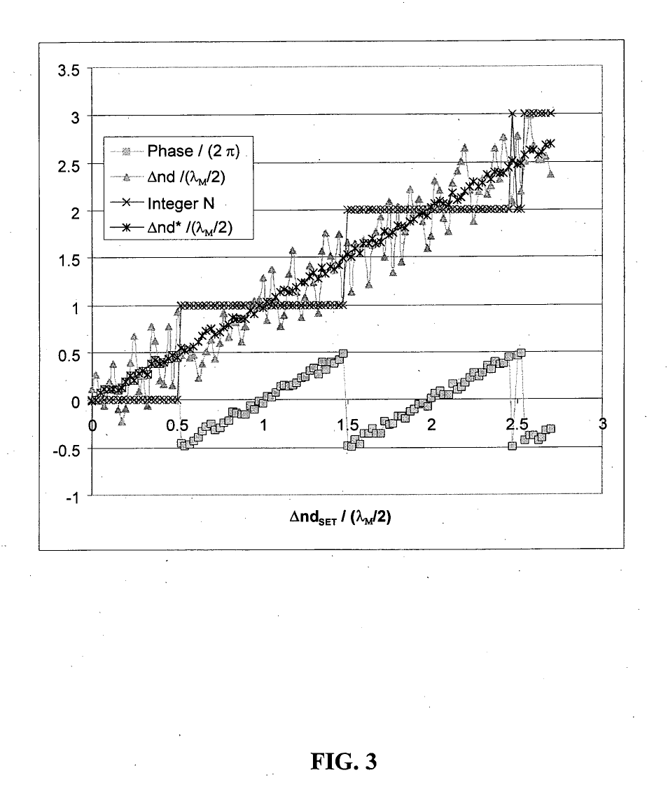

The attainable improvement to the separation determination through the one-step iteration (5) with integer requirement (4) is illustrated in FIG. 3. Separation changes Δnd_{SET} between 0 and 2.7 λ_{M}/2 are used in a numerical modelling. The phase and spatial frequency of the signal are calculated and provided with noise. The noisy measurement data Δnd [unit: λ_{M}/2] and Δφ[unit: λ_{M}/2] are plotted against the given Δnd_{SET} (x axis), together with the integer N, determined therefrom and the result Δnd* calculated according to (5) [unit: λ_{M}/2]. It is e.g. clear how at approximately 2.5 λ_{M}/2 a faulty measurement resulting from noise of Δnd and Δφleads to a sudden integer change and in this way compensates the error in Δnd*.

Subsequently, and as hereinbefore, the reproducibility of the method is to be evaluated. The only uncertainty results from the phase measurement. For simplification purposes, the phase φ_{S} at the starting point of a measurement series is considered and for which the true value is assumed as φ_{S}=0. The coefficients of the cosine and sine series are Cᵢ and Sᵢ.

The factor of the signal/noise ratio is smaller than the coefficient of the cosine term of the spectral component of the peak C_{P}. The coefficient of the corresponding sine term S_{P} does not generally disappear and instead has a magnitude like the remaining coefficients. The measured phase φ_{S} is determined by the formation of φ_{S}=arctan(S_{P}/C_{P}). The result will be a small value, making it possible to use for arctan, a linear approximation (x≈arctan(x)). This means that the phase φ_{S} has a standard deviation of approximately 1/(S/N). It immediately follows from (5) that the error of Δnd* is of the order of magnitude of λ_{M}/4π(S/N). With the previous numerical examples there is a value below 0.1 nm, i.e. roughly the diameter of an atom. On this scale, it is immediately possible to notice even very small changes, such as temperature and vibrations, so that here other very rapidly influencing factors influence the experimental results.

Compared with the established methods, the presently described method has the advantage that it is technically comparatively simple and therefore inexpensive.

The only disadvantage of the method is that the state of the material surfaces influences the phase position of the reflected wave. With the present method this effect cannot be differentiated from a true separation change. Particularly, in the case of the measurement of molecular coatings on special substrates, e.g. biochips, the phase jump effect is probably dominant. However, this can also simplify the detection of a thin coating, because its presence is “overemphasized”. Therefore, if less interest is attached to the precise coating thickness than to the large-area presence thereof, this can now be done particularly easily.

The method described is not based on specific characteristics of the investigated materials and is therefore suitable for a wide range of samples. It functions non-destructively and in a non-contacting manner and the arrangement of the measurement device relative to the sample can be significantly varied (e.g. measurement in a vacuum chamber from the outside through a window).

Equivalent elements can be substituted for ones set forth herein to achieve the same results in the same way and in the same manner.

Having thus described the present invention in the detailed description of the preferred embodiment, what is desired to be obtained in Letters Patent is:

1. Method for interferometric determination of a change to an optical separation between two planes in a sample at a transition from a first to a second measurement point on said sample, said sample being illuminated with high bandwidth light, said sample at least partly transmitting for said light, and said planes constructed in a partly reflecting manner, the steps of the method comprising:
a) dispersing, spectrally, a superposition of light beams reflected at said planes for both said first and second measurement points;
b) producing a spectrogram as a result of said step of dispersing a superposition of light beams reflected at said planes for both said first and second measurement points;
c) determinating modulation frequencies and phase positions of said spectrogram and differentiating results of said determinating step;
d) concluding a first value for said optical separation change of said planes from a difference of said modulation frequencies; and
e) calculating a second value for an optical spacing change from said first value and differences from said phase positions.

2. The method according to claim 1, wherein one of two said planes is a reference plane, said reference plane being a surface of said sample.

3. The method according to claim 2, wherein said reference plane is highly reflecting.

4. The method according to claim 1, further comprising the steps of:
a) determining a plurality of measurement points in said modulation frequencies and said phase positions of said spectrogram; and
b) differentiating levels of value of said plurality of measuring points with respect to measured values of said first and second measurement points.

5. The method according to claim 4, further comprising the steps of:
a) storing, electronically, said plurality of measuring points;
b) evaluating said electronically stored said plurality of measuring points with a computer; and
c) determining an optimum value for said optical plane separation at all of said plurality of measuring points.

6. The method according to claim 5, wherein said optimum value for said optical plane separation is a value having a minimum amount of noise.

7. The method according to claim 5, wherein the step of determining said optimum value for said optical plane separation occurs at an end of said step of determining a plurality of measuring points.

8. The method according to claim 5, further comprising the step of varying, algorithmically, a reference wavelength for determining said phase differences.

9. The method according to claim 5, further comprising the step of varying, algorithmically, a reference wavelength for determining choices of a reference measurement point for said phase differences.
